(19) United States
(12) Patent Application Publication
(10) Pub. No.: US 2005/0026796 A1
(43) Pub. Date: Feb. 3, 2005

(54) Foam glass cleaning composition

(75) Inventors: Isabelle Leonard, Voroux-lez-Liers (BE); Patrick Diet, Aubin Neufchateau (BE)

Correspondence Address: Colgate-Palmolive Company, 909 River Road, P.O. Box 1343, Piscataway, NJ, 08855-1343, US

(73) Assignee: Colgate-Palmolive Company

(21) Appl. No.: 10/630,577

(22) Filed: Jul. 30, 2003

(51) Int. Cl. C11D 1/00

(52) U.S. Cl. 510/180

(57) ABSTRACT

A foam glass cleaning composition containing a propellant, a perfume ingredient, a cosurfactant, a surfactant, an anticorrosion system and water.

### FIELD OF THE INVENTION

This invention relates to a foam glass cleaning composition designed in particular for cleaning glass surfaces which exhibits an anti-rain effect which is better spreading of rain on the window pane, easier wiping and shorter drying time.

### BACKGROUND OF THE INVENTION

In recent years all-purpose liquid detergents have become widely accepted for cleaning hard surfaces, e.g., window panes painted woodwork and panels, tiled walls, wash bowls, bathtubs, linoleum or tile floors, washable wall paper, etc. Such all-purpose liquids comprise clear and opaque aqueous mixtures of water-soluble synthetic organic detergents and water-soluble detergent builder salts. In order to achieve comparable cleaning efficiency with granular or powdered all-purpose cleaning compositions, use of water-soluble inorganic phosphate builder salts was favored in the prior art all-purpose liquids. For example, such early phosphate-containing compositions are described in U.S. Pat. Nos. 2,560,839; 3,234,138; 3,350,319; and British Patent No. 1,223,739.

In view of the environmentalist's efforts to reduce phosphate levels in ground water, improved all-purpose liquids containing reduced concentrations of inorganic phosphate builder salts or non-phosphate builder salts have appeared. A particularly useful self-opacified liquid of the latter type is described in U.S. Pat. No. 4,244,840.

However, these prior art all-purpose liquid detergents containing detergent builder salts or other equivalent tend to leave films, spots or streaks on cleaned unrinsed surfaces, particularly shiny surfaces. Thus, such liquids require thorough rinsing of the cleaned surfaces which is a time-consuming chore for the user.

In order to overcome the foregoing disadvantage of the prior art all-purpose liquid, U.S. Pat. No. 4,017,409 teaches that a mixture of paraffin sulfonate and a reduced concentration of inorganic phosphate builder salt should be employed. However, such compositions are not completely acceptable from an environmental point of view based upon the phosphate content. On the other hand, another alternative to achieving phosphate-free all-purpose liquids has been to use a major proportion of a mixture of anionic and nonionic detergents with minor amounts of glycol ether solvent and organic amine as shown in U.S. Pat. No. 3,935,130. Again, this approach has not been completely satisfactory and the high levels of organic detergents necessary to achieve cleaning cause foaming which, in turn, leads to the need for thorough rinsing which has been found to be undesirable to today's consumers.

Another approach to formulating hard surfaced or all-purpose liquid detergent composition where product homogeneity and clarity are important considerations involves the formation of oil-in-water (o/w) microemulsions which contain one or more surface-active detergent compounds, a water-immiscible solvent (typically a hydrocarbon solvent), water and a “cosurfactant” compound which provides product stability. By definition, an o/w microemulsion is a spontaneously forming colloidal dispersion of “oil” phase particles having a particle size in the range of 25 Å to 800 Å in a continuous aqueous phase.

In view of the extremely fine particle size of the dispersed oil phase particles, microemulsions are transparent to light and are clear and usually highly stable against phase separation.

Patent disclosures relating to use of grease-removal solvents in o/w microemulsions include, for example, European Patent Applications EP 0137615 and EP 0137616—Herbots et al; European Patent Application EP 0160762—Johnston et al; and U.S. Pat. No. 4,561,991—Herbots et al. Each of these patent disclosures also teaches using at least 5% by weight of grease-removal solvent.

It also is known from British Patent Application GB 2144763A to Herbots et al, published Mar. 13, 1985, that magnesium salts enhance grease-removal performance of organic grease-removal solvents, such as the terpenes, in o/w microemulsion liquid detergent compositions. The compositions of this invention described by Herbots et al. require at least 5% of the mixture of grease-removal solvent and magnesium salt and preferably at least 5% of solvent (which may be a mixture of water-immiscible non-polar solvent with a sparingly soluble slightly polar solvent) and at least 0.1 % magnesium salt.

However, since the amount of water immiscible and sparingly soluble components which can be present in an o/w microemulsion, with low total active ingredients without impairing the stability of the microemulsion is rather limited (for example, up to 18% by weight of the aqueous phase), the presence of such high quantities of grease-removal solvent tend to reduce the total amount of greasy or oily soils which can be taken up by and into the microemulsion without causing phase separation.

The following representative prior art patents also relate to liquid detergent cleaning compositions in the form of o/w microemulsions: U.S. Pat. No. 4,472,291—Rosario; U.S. Pat. No. 4,540,448—Gauteer et al; U.S. Pat. No. 3,723,330—Sheflin; etc.

Liquid detergent compositions which include terpenes, such as d-limonene, or other grease-removal solvent, although not disclosed to be in the form of o/w microemulsions, are the subject matter of the following representative patent documents: European Patent Application 0080749; British Patent Specification 1,603,047; 4,414,128; and 4,540,505. For example, U.S. Pat. No. 4,414,128 broadly discloses an aqueous liquid detergent composition characterized by, by weight:
(a) from 1% to 20% of a synthetic anionic, nonionic, amphoteric or zwitterionic surfactant or mixture thereof;
(b) from 0.5% to 10% of a mono- or sesquiterpene or mixture thereof, at a weight ratio of (a):(b) lying in the range of 5:1 to 1:3; and
(c) from 0.5% 10% of a polar solvent having a solubility in water at 15° C. in the range of from 0.2% to 10%. Other ingredients present in the formulations disclosed in this patent include from 0.05% to 2% by weight of an alkali metal, ammonium or alkanolammonium soap of a C₁₃-C₂₄ fatty acid; a calcium sequestrant from 0.5% to 13% by weight; non-aqueous solvent, e.g., alcohols and glycol ethers, up to 10% by weight; and hydrotropes, e.g., urea, ethanolamines, salts of lower alkylaryl sulfonates, up to 10% by weight. All of the formulations shown in the Examples of this patent include relatively large amounts of detergent builder salts which are detrimental to surface shine.

### SUMMARY OF THE INVENTION

The present invention provides a foam glass cleaning composition having improved anti-rain effect, shorter drying times, easier wiping and does not drip or run down a glass vertical surface thereby minimizing streaking.

The invention generally provides a foam glass cleaning composition which comprises approximately by weight:
(a) 1% to 8% of a propellant mixture; and
(b) 92% to 99% of a glass cleaning composition which comprises approximately by weight:
   (i) from 0.05% to 6% of an anionic surfactant;
   (ii) from 0.1% to 6% of a water-mixable cosurfactant having either limited ability or substantially no ability to dissolve oily or greasy soil;
   (iii) 0.01% to 0.5% of magnesium sulfate;
   (iv) 0.1% to 4% of a C₁ to C₃ alcohol;
   (v) 0.01% to 1.0% of an anticorrosion system;
   (vi) 0.01 to 1.0% of a perfume; and
   (vii) the balance being water, wherein sodium hydroxide is added to the composition to adjust the pH of the composition to about 7 to about 9.5 and optionally 0.1 wt. % to 5 wt. % of a humectant such as glycerol can be incorporated in the composition.

### DETAILED DESCRIPTION OF THE INVENTION

The present invention relates to a glass cleaning composition approximately by weight: 0.05% to 6% of an anionic surfactant, 0.1% to 6% of a cosurfactant, 0.01% to 0.5% of magnesium sulfate, 0.01% to 1% of a perfume, 0.01% to 1% of at least one anticorrosion system, 0.1% to 4% of a C₁ to C₃ alcohol such as ethanol or isopropanol and the balance being water, wherein 92% to 99% of the cleaning composition is mixed with 1% to 8% of a propellant mixture and the mixture is packaged in an aerosol container. The cleaning composition can contain 0.1% to 5% of a humectant such as glycerol.

As used herein and in the appended claims the term “perfume” is used in its ordinary sense to refer to and include any non-water soluble fragrant substance or mixture of substances including natural (i.e., obtained by extraction of flower, herb, blossom or plant), artificial (i.e., mixture of natural oils or oil constituents) and synthetically produced substance) odoriferous substances. Typically, perfumes are complex mixtures of blends of various organic compounds such as alcohols, aldehydes, ethers, aromatic compounds and varying amounts of essential oils (e.g., terpenes) such as from 0% to 80%, usually from 10% to 70% by weight, the essential oils themselves being volatile odoriferous compounds and also serving to dissolve the other components of the perfume.

In the present invention the precise composition of the perfume is of no particular consequence to cleaning performance so long as it meets the criteria of water immiscibility and having a pleasing odor. Naturally, of course, especially for cleaning compositions intended for use in the home, the perfume, as well as all other ingredients, should be cosmetically acceptable, i.e., non-toxic, hypoallergenic, etc. The instant compositions show a marked improvement in ecotoxocity as compared to existing commercial products.

The water-soluble organic detergent materials which are used in forming the glass cleaning compositions of this invention are selected from the group consisting of water-soluble, non-soap, anionic surfactants which may be mixed with a partially esterified ethoxylated polyhydric alcohol such as a partially esterified ethoxylated glycerol and/or a nonionic surfactant and/or a betaine surfactant.

Regarding the anionic surfactant present in the cleaning compositions any of the conventionally used water-soluble anionic surfactants or mixtures of said anionic detergents and anionic detergents can be used in this invention. As used herein the term “anionic surfactant” is intended to refer to the class of anionic and mixed anionic-nonionic surfactants providing detersive action.

Suitable water-soluble non-soap, anionic surfactants include those surface-active or detergent compounds which contain an organic hydrophobic group containing generally 8 to 26 carbon atoms and preferably 10 to 18 carbon atoms in their molecular structure and at least one water-solubilizing group selected from the group of sulfonate, sulfate and carboxylate so as to form a water-soluble surfactant. Usually, the hydrophobic group will include or comprise a C₈-C₂₂ alkyl, alkyl or acyl group. Such surfactants are employed in the form of water-soluble salts and the salt-forming cation usually is selected from the group consisting of sodium, potassium, ammonium, magnesium and mono-, di- or tri-C₂-C₃ alkanolammonium, with the sodium, magnesium and ammonium cations again being preferred.

Examples of suitable sulfonated anionic surfactants are the well known higher alkyl mononuclear aromatic sulfonates such as the higher alkyl benzene sulfonates containing from 10 to 16 carbon atoms in the higher alkyl group in a straight or branched chain, C₈-C₁₅ alkyl toluene sulfonates and C₈-C₁₅ alkyl phenol sulfonates.

A preferred sulfonate is linear alkyl benzene sulfonate having a high content of 3- (or higher) phenyl isomers and a correspondingly low content (well below 50%) of 2- (or lower) phenyl isomers, that is, wherein the benzene ring is preferably attached in large part at the 3 or higher (for example, 4, 5, 6 or 7) position of the alkyl group and the content of the isomers in which the benzene ring is attached in the 2 or 1 position is correspondingly low. Particularly preferred materials are set forth in U.S. Pat. No. 3,320,174.

Other suitable anionic surfactants are the olefin sulfonates, including long-chain alkene sulfonates, long-chain hydroxyalkane sulfonates or mixtures of alkene sulfonates and hydroxyalkane sulfonates. These olefin sulfonate detergents may be prepared in a known manner by the reaction of sulfur trioxide (SO₃) with long-chain olefins containing 8 to 25, preferably 12 to 21 carbon atoms and having the formula RCH═CHR₁ where R is a higher alkyl group of 6 to 23 carbons and R₁ is an alkyl group of 1 to 17 carbons or hydrogen to form a mixture of sultones and alkene sulfonic acids which is then treated to convert the sultones to sulfonates. Preferred olefin sulfonates contain from 14 to 16 carbon atoms in the R alkyl group and are obtained by sulfonating an a-olefin.

Other examples of suitable anionic sulfonate surfactants are the paraffin sulfonates containing 10 to 20, preferably 13 to 17, carbon atoms. Primary paraffin sulfonates are made by reacting long-chain alpha olefins and bisulfites and paraffin sulfonates having the sulfonate group distributed along the paraffin chain are shown in U.S. Pat. Nos. 2,503,280; 2,507,088; 3,260,744; 3,372,188; and German Patent 735,096.

Examples of satisfactory anionic sulfate surfactants are the C₈-C₁₈ alkyl sulfate salts and the C₈-C₁₈ alkyl sulfate salts and the C₈-C₁₈ alkyl ether polyethenoxy sulfate salts having the formula R(OC₂H₄)ₙ OSO₃M wherein n is 1 to 12, preferably 1 to 5, and M is a solubilizing cation selected from the group consisting of sodium, potassium, ammonium, magnesium and mono-, di- and triethanol ammonium ions. The alkyl sulfates may be obtained by sulfating the alcohols obtained by reducing glycerides of coconut oil or tallow or mixtures thereof and neutralizing the resultant product. On the other hand, the alkyl ether polyethenoxy sulfates are obtained by sulfating the condensation product of ethylene oxide with a C₈-C₁₈ alkanol and neutralizing the resultant product. The alkyl sulfates may be obtained by sulfating the alcohols obtained by reducing glycerides of coconut oil or tallow or mixtures thereof and neutralizing the resultant product. On the other hand, the alkyl ether polyethenoxy sulfates are obtained by sulfating the condensation product of ethylene oxide with a C₈-C₁₈ alkanol and neutralizing the resultant product. The alkyl ether polyethenoxy sulfates differ from one another in the number of moles of ethylene oxide reacted with one mole of alkanol. Preferred alkyl sulfates and preferred alkyl ether polyethenoxy sulfates contain 10 to 16 carbon atoms in the alkyl group.

The C₈-C₁₂ alkylphenyl ether polyethenoxy sulfates containing from 2 to 6 moles of ethylene oxide in the molecule also are suitable for use in the inventive compositions. These detergents can be prepared by reacting an alkyl phenol with 2 to 6 moles of ethylene oxide and sulfating and neutralizing the resultant ethoxylated alkylphenol.

Obviously, these anionic surfactants will be present either in acid form or salt form depending upon the pH of the final composition, with salt forming cation being the same as for the other anionic detergents.

The cosurfactant may play an essential role in the formation of the glass cleaning composition. Compounds that have been found to provide highly suitable cosurfactants for the instant compositions over temperature ranges extending from 5° C. to 43° C. for instance are water-soluble C₃-C₄ alkanols, polypropylene glycol of the formula HO(CH₃CHCH₂O)ₙH wherein n is a number from 2 to 18 and monoalkyl ethers and esters of ethylene glycol and propylene glycol having the structural formulas R(X)ₙOH and R₁(X)ₙOH wherein R is C₁-C₆ alkyl, R₁ is C₂-C₄ acyl group, X is (OCH₂CH₂) or (OCH₂(CH₃)CH) and n is a number from 1 to 4.

Representative members of the polypropylene glycol include dipropylene glycol and polypropylene glycol having a molecular weight of 200 to 1000, e.g., polypropylene glycol 400. Other satisfactory glycol ethers are ethylene glycol monobutyl ether (butyl cellosolve), diethylene glycol monobutyl ether (butyl carbitol), triethylene glycol monobutyl ether, mono, di, tri propylene glycol mono- or tetra-butyl ether, tetraethylene glycol monobutyl ether, propylene glycol tertiary butyl ether, ethylene glycol monoacetate and dipropylene glycol propionate.

The amount of cosurfactant required to stabilize the glass cleaning compositions will, of course, depend on such factors as the surface tension characteristics of the cosurfactant, the type and amounts of the primary surfactants and perfumes, and the type and amounts of any other additional ingredients which may be present in the composition and which have an influence on the thermodynamic factors enumerated above.

The composition contains an inorganic or organic salt of oxide or sulfate of a multivalent metal cation, particularly Mg⁺⁺. The metal salt or oxide provides several benefits including improved cleaning performance in dilute usage, particularly in soft water areas, and minimized amounts of perfume required to obtain the microemulsion state. Magnesium sulfate, either anhydrous or hydrated (e.g., heptahydrate), is especially preferred as the magnesium salt. Good results also have been obtained with magnesium oxide, magnesium chloride, magnesium acetate, magnesium propionate and magnesium hydroxide. These magnesium salts can be used with formulations at neutral or acidic pH since magnesium hydroxide will not precipitate at these pH levels.

Although magnesium is the preferred multivalent metal from which the salts (inclusive of the oxide and hydroxide) are formed, other polyvalent metal ions also can be used provided that their salts are nontoxic and are soluble in the aqueous phase of the system at the desired pH level. Thus, depending on such factors as the pH of the system, the nature of the primary surfactants and cosurfactant, and so on, as well as the availability and cost factors, other suitable polyvalent metal ions include aluminum, copper, nickel, iron, calcium, etc.

The anti-rain system of the instant invention is a mixture of phosphoric acid and a nitrogen containing organic compound which is characterized by the formula: 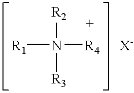
wherein R₁ is a methyl group and R₂, R₃ and R₄ are independently selected from the group consisting of methyl, ethyl, CH₂CH₂Y and CH₂CH₂CH₂Y, wherein Y is selected from the group consisting of Cl, Br, CO2H, (CH₂O)ₙ OH wherein n=1 to 10 and OH, and X⁻ is selected from the group consisting of C1, Br, and methosulfate 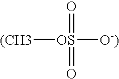
Preferred anti-rain agents are beta-hydroxyethyltrimethyl ammonium chloride (choline chloride), beta-chloroethyltrimethyl ammonium chloride, and tri(beta-hydroxyethyl) methyl ammonium methosulfate (Stephan Quat), wherein the choline chloride is preferred.

The anti-corrosion system of the instant invention will either be a combination of benzoate salt with a nitrogen source like Sodium Nitrite or another component like Sodium silicate, Sodium salicylate, sodium lauroyl sarcosinate. To improve corrosion inhibition, a low level of ammonia of approximately by weight 0.01 to 0.5% will be added to the composition either with one or a combination of several of the corrosion inhibitor mentioned above. The composition will comprises approximately by weight 0.1 to 1% of the anticorrosion mentioned above either alone or in combination.

The propellant mixture comprises approximately by weight: 45% to 55% of butane, 15% to 25% of isopentane and 15% to 25% of propane.

The glass cleaning composition of this invention may, if desired, also contain other components either to provide additional effect or to make the product more attractive to the consumer. The following are mentioned by way of example: Colors or dyes in amounts up to 0.5% by weight; bactericides in amounts up to 1% by weight; preservatives or antioxidizing agents, such as formalin, 5-bromo-5-nitro-dioxan-1,3; 5-chloro-2-methyl-4-isothaliazolin-3-one, 2,6-di-tert.butyl-p-cresol, etc., in amounts up to 2% by weight; and pH adjusting agents, such as sulfuric acid or sodium hydroxide, as needed. Furthermore, if opaque compositions are desired, up to 4% by weight of an opacifier may be added.

Because the compositions as prepared are aqueous liquid formulations and since no particular mixing is required to form the glass cleaning compositions, the compositions are easily prepared simply by combining all the ingredients in a suitable vessel or container. The order of mixing the ingredients is not particularly important and generally the various ingredients can be added sequentially or all at once or in the form of aqueous solutions of each or all of the primary detergents and cosurfactants can be separately prepared and combined with each other and with the perfume. The magnesium salt, or other multivalent metal compound, when present, can be added as an aqueous solution thereof or can be added directly. It is not necessary to use elevated temperatures in the formation step and room temperature is sufficient.

The instant glass cleaning formulas explicitly exclude alkali metal silicates and alkali metaL builders such as alkali metal polyphosphates, alkali metal carbonates, alkali metal phosphonates and alkali metal citrates because these materials, if used in the instant composition, would cause the composition to have a high pH as well as leaving residue on the surface being cleaned.

The following examples illustrate liquid cleaning compositions of the described invention. Unless otherwise specified, all percentages are by weight. The exemplified compositions are illustrative only and do not limit the scope of the invention. Unless otherwise specified, the proportions in the examples and elsewhere in the specification are by weight.

### EXAMPLE 1

The following composition in wt. % was prepared:

| | A | B | Competitor | Competitor |
|---|---|---|---|---|
| | Wt. % | Wt. % | Cif | Sidolin |
| Part I - propellant | | | | |
| mixture | | | | |
| Butaine | 60 | 60 | | |
| Isobutaine | 20 | 20 | | |
| Propane | 20 | 20 | | |
| Part II - cleaning | | | | |
| composition | | | | |
| Ethanol | 3 | 3 | | |
| Propylene glycol | 3 | 3 | | |
| mono butyl ether | | | | |
| Perfume | 0.055 | 0.055 | | |
| C12-C14 sodium salt | 0.21 | 0.21 | | |
| of C12-C14 alkyl | | | | |
| ether sulfate | | | | |
| Choline chloride | 0.133 | 0.133 | | |
| Magnesium sulfate | 0.08 | 0.08 | | |
| hepta hydrate | | | | |
| Salicylic acid | 0 | 0.15 | | |
| Water | 93.522 | 93.505 | | |
| Final cleaning | | | | |
| composition | | | | |
| Part I | 3.5 | | | |
| Part II | 96.5 | | | |
| Degreasing (% | 77.3% | | | 62.2 |
| removal) | | | | |
| Degreasing (% | 102.4% | | 89.1% | |
| removal) | | | | |
| Degreasing (% | | — | | |
| removal) | | | | |
| Residue | OK | OK | Less good | similar |
| Antifog effect | — | — | — | — |
| Vertical cling | OK | OK | similar | similar |
| Wipe ease | OK | OK | similar | similar |
| Streaking | OK | OK | similar | similar |

1. A foam glass cleaning composition comprising approximately by weight:
(a) 1% to 8% of a propellant mixture; and
(b) 92% to 99% of a glass cleaning composition comprising approximately by weight:
(i) 0.05 wt. % to 6 wt. % of an anionic surfactant;
(ii) 0.1 wt. % to 6 wt. % of a cosurfactant;
(iii) 0 wt. % to 1.0 wt. % of a perfume;
(iv) 0.05% to 1% of an anticorrosion system;
(v) 0.1 to 4% of a C₁ to C₃ alcohol;
(vi) 0.01% to 0.5% of inorganic magnesium salt; and
(vii) the balance being water.

2. The foam cleaning composition of claim 1 wherein the cosurfactant is a water soluble glycol ether.

3. The foam cleaning composition of claim 2 wherein the glycol ether is selected from the group consisting of ethylene glycol monobutyl ether, diethylene glycol monobutyl ether, triethylene glycol monobutyl ether, propylene glycol tert.butyl ether and mono-, di-, tri-propylene glycol monobutyl ether and mixtures thereof.

4. The foam cleaning composition of claim 3 wherein the glycol ether is propylene glycol monobutyl ether or diethylene glycol monobutyl ether.

5. The cleaning composition of claim 1 wherein the anticorrosion system comprises Sodium benzoate, sodium silicate, sodium salicylate, sodium lauroyl sarcosinate and ammonia either in combination or alone.

6. The cleaning composition of claim 1, wherein the inorganic magnesium salt is magnesium sulfate-heptahydrate.
